(19) United States
(12) Patent Application Publication
(10) Pub. No.: US 2019/0346169 A1
(43) Pub. Date: Nov. 14, 2019

(54) SYSTEMS AND METHODS FOR VOICE-ENABLED ACCESS OF BUILDING MANAGEMENT SYSTEM DATA

(71) Applicant: Johnson Controls Technology Company, Auburn Hills, MI (US)

(72) Inventors: Sachin Yashwant Pate, Andheri (East) (IN); Subrata Bhattacharya, Nerul (IN); Ankur Thareja, Alwar (IN); Vijay Sopanrao Patil, Sangli (IN); Rohit Bhagwan Mansukhani, Powai (IN); Ovijeet Sircar, Kolkata (IN); Megha vitthal Sawant, Satara (IN)

(73) Assignee: Johnson Controls Technology Company, Auburn Hills, MI (US)

(21) Appl. No.: 15/974,292

(22) Filed: May 8, 2018

(51) Int. Cl. F24F 11/526; F24F 11/523; F24F 11/58; F24F 11/64; F24F 11/65

(52) U.S. Cl. CPC F24F 11/526; F24F 11/523; F24F 11/58; F24F 2120/20; F24F 11/65; G05B 2219/2614; F24F 11/64

(57) ABSTRACT

A system for monitoring and controlling devices within a building management system (BMS). The system includes a user device configured to receive and convert a vocal input to voice data, and a BMS processor in communication with the user device and an operating device within the BMS. The BMS processor converts voice data to intent and entity parameters, and determines if the intent parameter is a visual intent or an audio intent. If the intent parameter is a visual intent, the BMS processor determines a category corresponding to the entity parameter, and outputs a web page corresponding to the category. Additionally, if the intent parameter is an audio intent, the BMS processor determines a category corresponding to the entity parameter, and retrieves and outputs operating device data corresponding to the category. Further, the user device outputs audio data corresponding to the operating device data and displays the web page.

### BACKGROUND

The present disclosure relates generally to a building management system. The present disclosure relates more particularly to systems and methods for providing access to building management system data using vocal inputs.

A building management system (BMS) is, in general, a system of devices configured to control, monitor, and manage equipment in or around a building or building area. A BMS can include a heating, ventilation, and air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include a variety of devices (e.g., HVAC devices, controllers, chillers, fans, sensors, etc.) configured to facilitate monitoring and controlling the building space.

Currently, many building management systems provide control of an entire facility, building, or other environment. For example, a building management system can be configured to monitor multiple buildings, each having HVAC systems, water system, lights, air quality, security, and/or any other aspect of the facility within the purview of the building management system. Some buildings may have several floors and each floor may be divided into a number of sections. Accordingly, building equipment and devices may be associated with a building, floor, and/or section.

A building management system may allow a user to access building information via a user interface of a computing device. For example, a user interface can be a web-based application that allows a user to selectively access building equipment data. However, navigating a web-based application or other interfaces can be a time-consuming and difficult process, particularly for inexperienced users. A user may be required to manually click through various web pages of the web-based application to find and locate particular building equipment within a building, a floor, and a section. Furthermore, in some implementations, a building management system may be configured to monitor several buildings, increasing the total number of building equipment and overall complexity.

As users continue to rely on smart devices and other portable computing devices (e.g., smart phones, wearable devices), interacting with a building management system through a user interface can become increasingly difficult. For example, navigating through a web-based application on a smart phone can take longer than on a desktop computer. Some user devices, such as smart watches, are inherently limited in their navigation and display capabilities.

### SUMMARY

One implementation of the present disclosure is a system for monitoring and controlling devices within a building management system (BMS). The system includes a user device configured to receive a vocal input and convert the vocal input to voice data, and a BMS processor in communication with the user device and at least one operating device within the BMS. The BMS processor is configured to convert voice data to at least one intent parameter and at least one entity parameter, and determine if the at least one intent parameter is one of a visual intent or an audio intent. In response to a determination that the at least one intent parameter is the visual intent, the BMS processor is configured to determine at least one category corresponding to the at least one entity parameter, and select and output a web page corresponding to the at least one category. Further, in response to a determination that the at least one intent parameter is the audio intent, the BMS processor is configured to determine at least one category corresponding to the at least one entity parameter, and retrieve and output operating device data corresponding to the at least one category. Additionally, the user device is configured to output audio data corresponding to the operating device data and further configured to display the web page.

In some embodiments, the BMS processor is configured to execute a plurality of web page navigation steps in response to a single vocal input. Additionally, in some embodiments, the BMS processor is configured to determine a user identity corresponding to the vocal input, and customize the output data using the user identity.

In some embodiments, retrieving operating data includes requesting operating data from a BMS application program interface (API) server, and retrieving operating data from a BMS database via the BMS API server.

In some embodiments, the BMS processor is configured to prompt a user input corresponding to a display type prior to outputting the web page. Additionally, in some embodiments, the at least one category corresponds to a BMS category selected from a group consisting of energy, equipment, and building.

In some embodiments, the BMS processor is further configured to receive the voice data, convert the voice data to text data, map at least one text element to the at least one intent parameter, and map at least one text element to the at least one entity parameter.

Another implementation of the present disclosure is a system for monitoring and controlling devices within a building management system (BMS). The system includes a user device configured to receive a vocal input and convert the vocal input to voice data, at least one operating device within a building, and a BMS processor in communication with the user device and the at least one operating device. The BMS processor is configured to receive the voice data from the user device, determine an intent parameter and at least one entity parameter from the voice data, and determine at least one category corresponding to the at least one entity parameter. The BMS processor is further configured to update at least one operating device parameter corresponding to the at least one category upon the determination that the intent parameter is a control intent, and communicate the at least one operating device parameter to the user device. Additionally, the user device is configured to provide at least one of an audio output and a visual output based on the updated at least one operating parameter.

In some embodiments, updating the at least one operating device parameter changes a device operation.

In some embodiments, the BMS processor is configured to determine and output a web page corresponding to the at least one category in response to a determination that the at least one intent parameter is a visual intent. Additionally, the BMS processor is configured to retrieve and output operating device data corresponding to the at least one category in response to a determination that the at least one intent parameter is an audio intent.

In some embodiments, the BMS processor is configured to update the at least one operating device parameter using a single vocal input.

Another implementation of the present disclosure is a method for monitoring and controlling devices within a building management system (BMS). The method includes receiving voice data via a user device. The method further includes converting the voice data to at least one intent parameter and at least one entity parameter using a speech conversion system. Additionally, the method includes determining a building identity using the building management system, and determining if the at least one intent parameter is one of a visual intent or an audio intent. In response to a determination that the at least one intent parameter is the visual intent, the method includes determining at least one category corresponding to the at least one entity parameter, selecting a web page based on the at least one category and the building identity, and displaying the web page on the user device. In response to a determination that the at least one intent parameter is the audio intent, the method further includes determining at least one category corresponding to the at least one entity parameter, retrieving data corresponding to the at least one category and the building identity, converting data to speech data, and outputting audio corresponding to the speech data on the user device.

In some embodiments, redirecting of the web page includes a plurality of navigation steps. Additionally, in some embodiments, converting the voice data further includes receiving the voice data, converting the voice data to text data, mapping at least one text element to the at least one intent parameter, and mapping at least one text element to the at least one entity parameter.

In some embodiments, the method further includes converting the at least one intent parameter and the at least one entity parameter to a JavaScript Object Notation (JSON) format.

In some embodiments, the at least one category corresponds to a BMS category selected from a group consisting of energy, equipment, and building. The method further includes determining at least one subcategory corresponding to the at least one category.

In some embodiments, the method further includes determining a user identity corresponding to the voice data, and customizing an output using the user identity.

In some embodiments, determining the building identity includes determining if the voice data corresponds to the building identity, and in response to a determination that the voice data does not correspond to the building identity, prompting additional input via the user device, the additional input corresponding to the building identity.

### BRIEF DESCRIPTION OF THE DRAWINGS

FIG. 1 is a drawing of a building equipped with a HVAC system, according to some embodiments.

FIG. 2 is a block diagram of a waterside system which can be used to serve the building of FIG. 1, according to some embodiments.

FIG. 3 is a block diagram of an airside system which can be used to serve the building of FIG. 1, according to some embodiments.

FIG. 4 is a block diagram of a building management system (BMS) which can be used to monitor and control the building of FIG. 1, according to some embodiments.

FIG. 5 is a block diagram of a voice-enabled system, which can be used to access the BMS of FIG. 4, according to some embodiments.

FIG. 6 is a block diagram of a voice-enabled controller in communication with a web server, according to some embodiments.

FIG. 7 is a block diagram of a speech conversion module, according to some embodiments.

FIG. 8 is a block diagram of a command identification module, according to some embodiments.

FIG. 9 is a flowchart of a process for receiving and responding to a vocal input, according to some embodiments.

FIG. 10 is a flowchart of a process for retrieving data from a BMS, according to some embodiments.

FIG. 11 is a flowchart of a process for receiving and responding to a vocal input, according to some embodiments.

FIG. 12A is a flowchart of a process for receiving, analyzing, and responding to a vocal input, according to some embodiments.

FIG. 12B is a continuation flowchart of the process of FIG. 12A for receiving and responding to a vocal input, according to some embodiments.

FIG. 13 is a flowchart of a process for receiving, analyzing, and responding to a vocal input, according to some embodiments.

FIG. 14 is a flowchart of a process for receiving and responding to a vocal input, according to some embodiments.

### DETAILED DESCRIPTION

### Overview

Many web-based applications enable users to access information by navigating through various web pages. In traditional settings, a user must click on the web pages to navigate. While manual clicking is relatively simple with some user devices (such as a desktop computer with a mouse and keyboard), navigation becomes very difficult for other user devices (such as smartphones and smartwatches). The user may struggle with the device's smaller user interface, and navigation can prove to be difficult. Further, the size of the user interface and/or display may limit what the user is able to see (and how it is displayed).

Some building management systems utilize web pages to monitor and/or control the corresponds systems, devices, and buildings. Even within a single building, navigating to a desired web page may take several steps. The navigation time becomes even greater when multiple buildings are being monitored by one building management system. As one example, if a user sees that “building 1” is consuming a greater amount of energy than usual, the user may wish to compare the energy usage of “building 1” to the energy usage of “building 2.” In this scenario, the user may have to navigate back to a common web page before being able to navigate to the web page that includes the energy usage of “building 2.”

Referring generally to the FIGURES, a building management system (BMS) and various components thereof are shown, according to an exemplary embodiment. The BMS includes sensors, building equipment, a building controller, and a voice-enabled system.

In some embodiments, the voice-enabled system may enable a user to request data from the BMS via a vocal input (e.g., a voice command). In some situations, the user may interact with the BMS without providing a physical input (e.g., without buttons, touching an HMI or user device, etc.). Accordingly, the voice-enabled system may be configured to execute a plurality of web page navigations within the BMS, using the vocal input. Further, the voice-enabled system may be configured to retrieve data within the BMS, using the vocal input.

In some embodiments, the vocal input may indicate that a user would like to view data corresponding to the BMS. The voice-enabled system may be configured to navigate to the data and display the data on a user device. Alternatively, the vocal input may indicate that a user would like to receive audio corresponding to the BMS data. The voice-enabled system may be configured to retrieve the data and output audio corresponding to the data via a user device. In some embodiments, the vocal input may indicate that a user would like to change an operating parameter within the BMS. The voice-enabled system may be configured to update the operating parameter and provide an indication to the user via a user device.

In some embodiments, the voice-enabled system may enable a user to update an operating device parameter corresponding to the BMS, via a vocal input. For example, a user may issue a voice command corresponding to increasing a temperature setpoint. The voice-enabled system may receive and analyze the vocal input, and communicate with the BMS to change an existing temperature setpoint.

In some embodiments, the voice-enabled system may communicate with a user device. The user device may be wired or wireless, and may be a laptop or desktop computer, and/or a smartphone, smartwatch, or other “smart” device.

In some embodiments, the voice-enabled system may be configured to convert vocal inputs (e.g., voice commands) to intent and entity parameters. The intent and entity parameters may be used by the voice-enabled system to determine a desired output corresponding to the vocal input. Further embodiments of the voice-enabled system are described in detail herein.

As used herein, an “intent parameter” may refer to a term or object within a vocal input that provides purpose (e.g., a desired action). Further, as used herein, an “entity parameter” may refer to a term or object within a vocal input that provides clarification or specific context for a particular intent (e.g., what the action pertains to). As one non-limiting example, a vocal input may be “show me the temperature.” In this example, “show me” corresponds to the intent parameter (what action the user is requesting), and “temperature” corresponds to the entity parameter (what specific element is tied to the requested action).

As used herein, a “smart device” may refer to an electronic device, generally connected to other devices or networks. The smart device may be connected to other devices or networks via different wireless protocols (e.g., Bluetooth, NFC, Wi-Fi, 3G, etc.).

### Building HVAC Systems and Building Management Systems

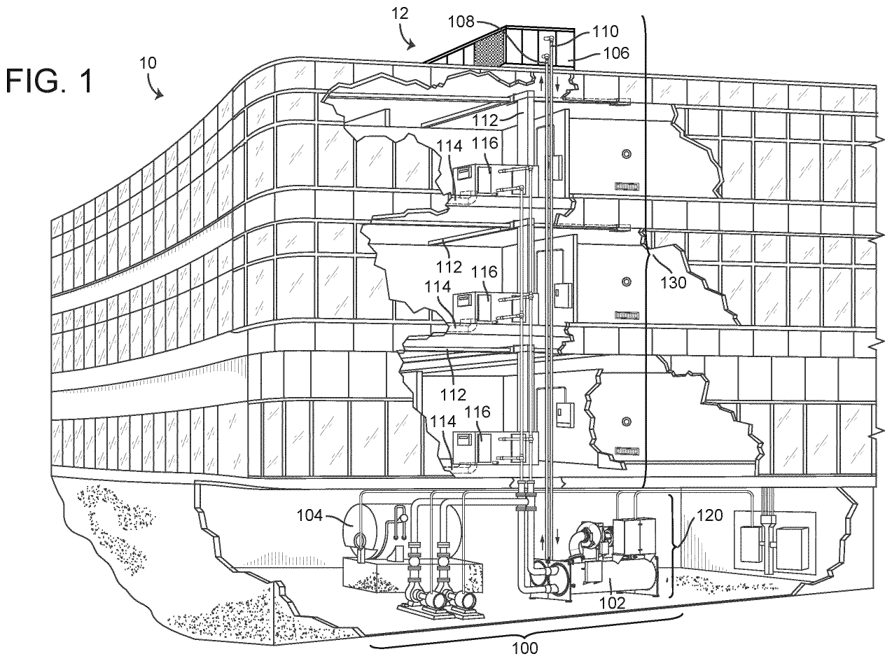

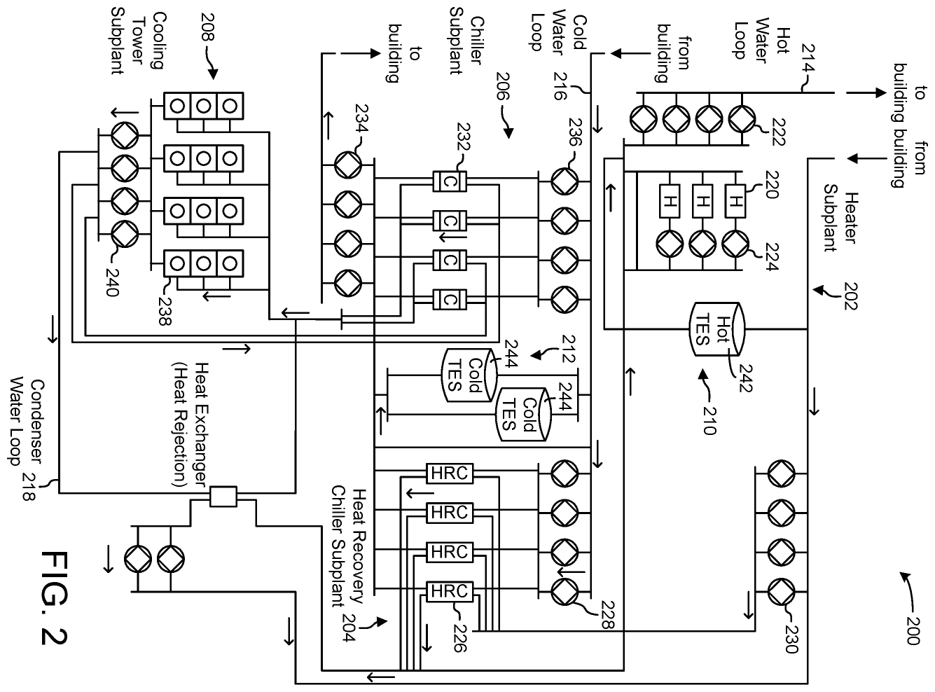

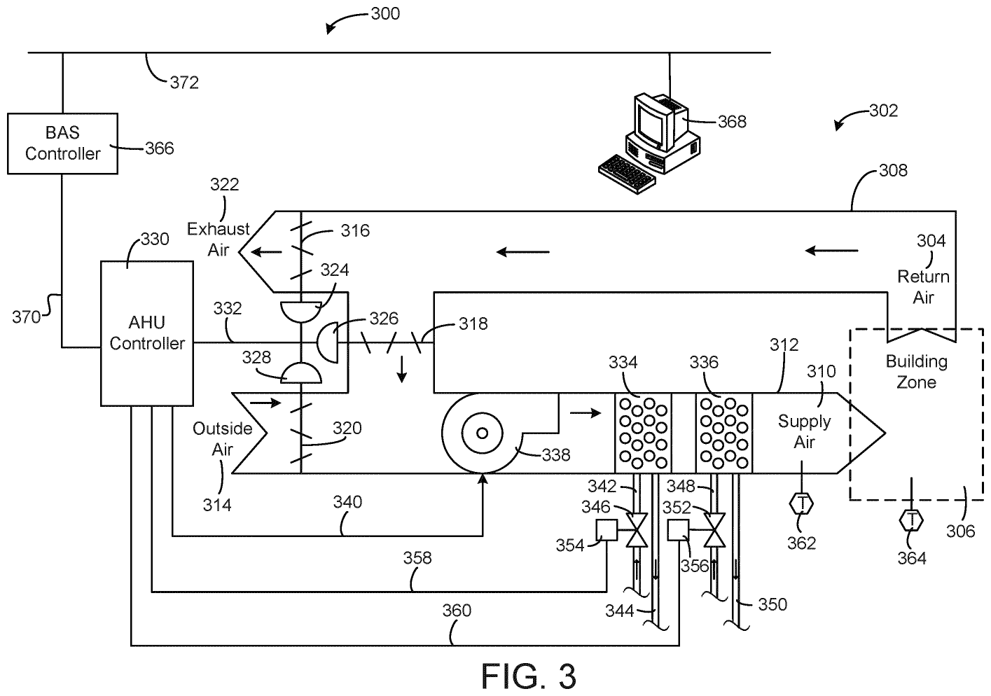

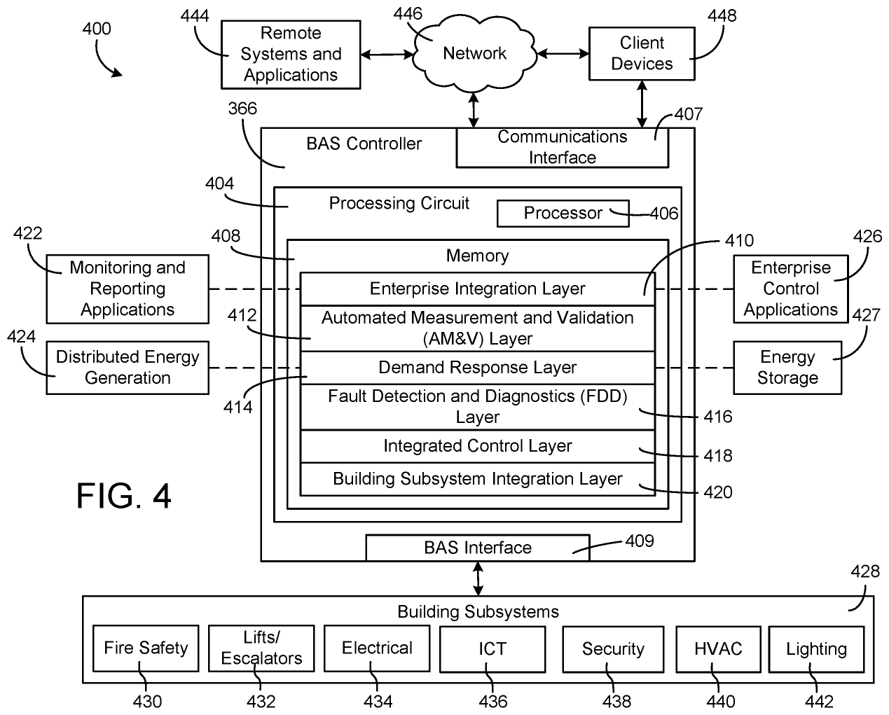

Referring now to FIGS. 1-4, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10.

### Building and HVAC System

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management Systems

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify whether control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Voice-Enabled Systems and Methods

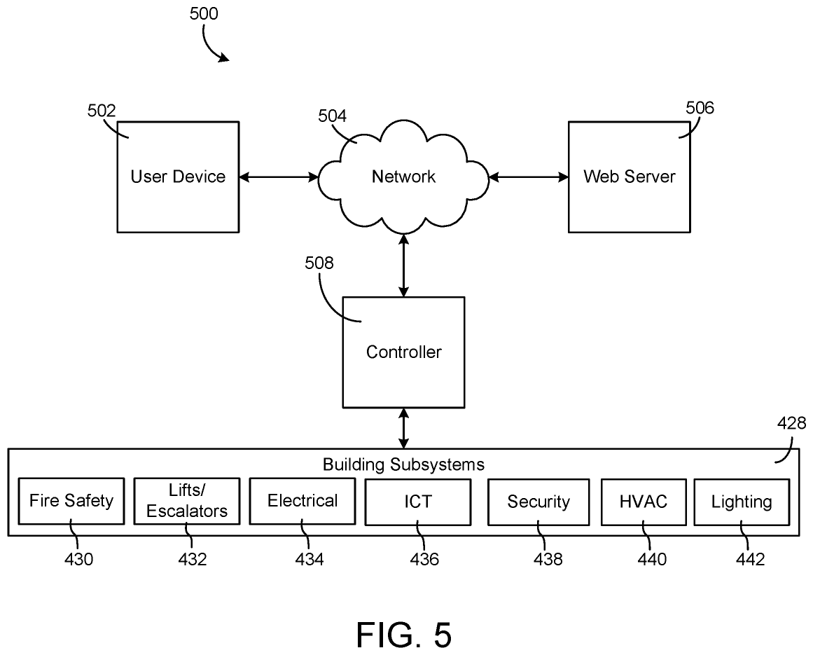

Referring now to FIGS. 5-14, systems and methods for voice-enabled interaction with a building management system (BMS) are shown according to some embodiments.

FIG. 5 is a block diagram of a voice-enabled system 500, which can be used to access the BMS of FIG. 4, according to some embodiments. As shown, a user device 502, a web server 506, and a controller 508 may all send and receive information via network 504. In this way, for example, data may be exchanged among user device 502, controller 508, and web server 506. In some embodiments, controller 508 may be the same or similar to BAS controller 366, as described with respect to FIG. 4. Further, in some embodiments, network 504 may be the same or similar to network 446, as described with respect to FIG. 4.

As shown, controller 508 may be configured to send and receive data from building subsystems 428, which may include electrical subsystem 434, information communication technology (ICT) subsystem 436, security subsystem 438, HVAC subsystem 440, lighting subsystem 442, lift/escalators subsystem 432, and fire safety subsystem 430.

In some embodiments, a user may interact with voice-enabled system 500 via user device 502. User device 502 may be, for example, a smartphone, smartwatch, laptop, desktop computer, tablet, or any other device configured to communicate via a wired or wireless network (e.g., network 504). In some embodiments, a user may submit a voice command (i.e., vocal input) to user device 502. In some situations, the voice command may correspond to receiving data visually or via audio, or may correspond to changing or determining an operating parameter. The operating parameter may relate to one or multiple of building subsystems 428 (e.g., a temperature setpoint within HVAC subsystem 440, a light brightness within lighting subsystem 442, etc.).

In some embodiments, a user may request, via user device 502, to view building information. User device 502 may communicate the request to controller 508, via network 504. Controller 508 may then communicate with web server 506. Web server 506 may be configured to interpret a vocal input, and reply with the vocal input in a revised format. In some embodiments, for example, the format may include intent and entity parameters, and/or may be expressed in JavaScript Object Notation (JSON) format. Alternatively, other data formats may be used. Controller 508 may receive the data from web server 506, and determine how to proceed.

As one non-limiting example, controller 508 may use the received data to determine that a visual output is needed. Alternatively, controller 508 may determine that an audio output is needed, or that a building operating parameter should be changed. Controller 508 may perform a plurality of web page navigations prior to displaying a web page that corresponds with a user's request for a visual output. Further, controller 508 may communicate with internal or external databases, servers, and/or building subsystems 428 to determine requested information, prior to outputting audio that corresponds with a user's request for an audio output.

In some embodiments, controller 508 may communicate with building subsystems 428 to determine a current building operating parameter, prior to changing the building operating parameter that corresponds with a user's request for change. In some embodiments, controller 508 may determine operating limits corresponding to the device specified within the user's request, prior to changing an operating parameter. Further, controller 508 may not change the operating parameter if the operating parameter would cause the equipment to exceed its corresponding operating limits.

If controller 508 determines that a visual output is needed, it may display the corresponding web page on a user interface of user device 502. Further, if controller 508 determines that an audio output is needed, it may utilize a text-to-speech conversion system. Once the text data is processed by the text-to-speech conversion system, user device 502 may output the data via speakers. If controller 508 determines that an operating parameter update is needed, it may update the operating parameter, which may cause a physical change within one or more of building subsystems 428.

In some embodiments, user device 502 and/or controller 508 may be configured to listen for a “trigger” word. A trigger word may be used to indicate that a vocal input from a user will follow. In some situations, user device 502 and/or controller 508 may not respond to a vocal input unless the trigger word was first issued.

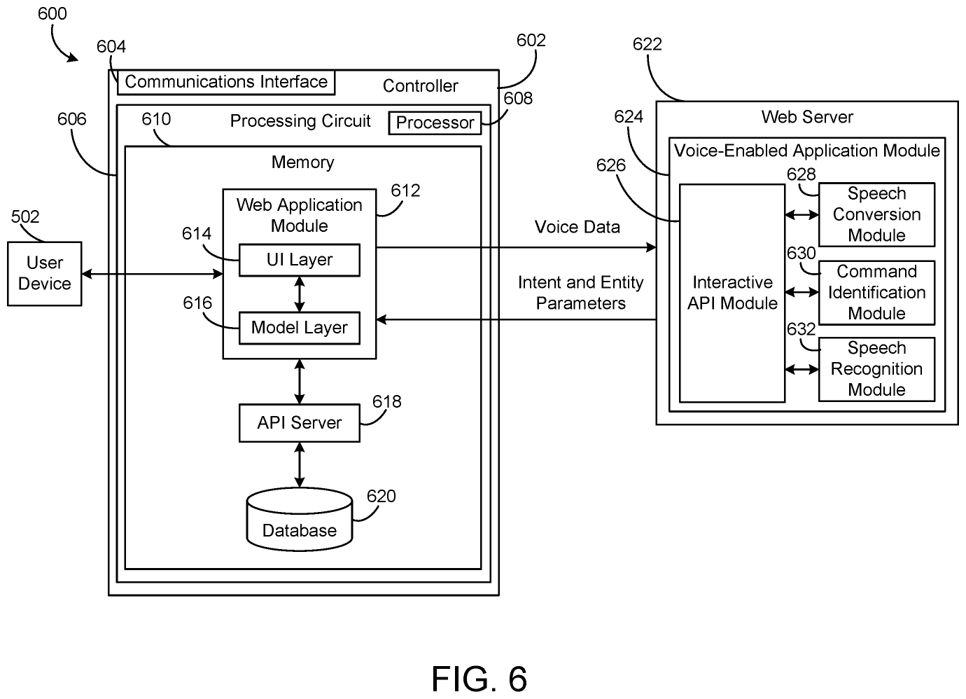

Referring now to FIG. 6, a voice-enabled system 600 is shown, according to some embodiments. Voice-enabled system 600 may include a controller 602. In some embodiments, controller 602 may be the same or similar to BAS controller 366 or controller 508, as shown and described herein. Controller 602 is shown to include a communications interface 604. Communications interface 604 may facilitate communications between controller 602 and external applications (e.g., monitoring and reporting applications, remote systems, user devices, etc.) for allowing user control, monitoring, and adjustment to controller 602 and/or any corresponding subsystems (e.g., building subsystems 428). Communications interface 604 may also facilitate communications between controller 602 and user device 502.

Communications interface 604 can be or include wired or wireless communications interfaces (e.g., jacks, antennas, transmitters, receivers, transceivers, wire terminals, etc.) for conducting data communications with building subsystems 428 or other external systems or devices (e.g., user device 502). In various embodiments, communications via communications interface 604 may be direct (e.g., local wired or wireless communications) or via a network (e.g., network 504, 446, a WAN, the Internet, a cellular network, etc.). For example, communications interface 604 can include an Ethernet card and port for sending and receiving data via an Ethernet-based communications link or network. In another example, communications interface 604 can include a WiFi transceiver for communicating via a wireless communications network. In another example, communications interface 604 may include cellular or mobile phone communications transceivers.

Still referring to FIG. 6, controller 602 is shown to include a processing circuit 606 including a processor 608 and memory 610. Processing circuit 606 may be communicably connected to communications interface 604 such that processing circuit 606 and the various components thereof can send and receive data via communications interface 604. Processor 608 can be implemented as a general purpose processor, an application specific integrated circuit (ASIC), one or more field programmable gate arrays (FPGAs), a group of processing components, or other suitable electronic processing components.

Memory 610 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 610 may be or include volatile memory or non-volatile memory. Memory 610 may include database components, object code components, script components, or any other type of information structure for supporting the various activities and information structures described in the present application. According to some embodiments, memory 610 may be communicably connected to processor 608 via processing circuit 606 and includes computer code for executing (e.g., by processing circuit 606 and/or processor 608) one or more processes described herein.

Still referring to FIG. 6, memory 610 is shown to include a web application module 612. In some embodiments, web application module may include a UI layer 614 and a model layer 616. Further, UI layer 614 and model layer 616 may be in communication with one another. As shown, in some embodiments, web application module 612 may be in communication with user device 502 (e.g., via communications interface 604). Additionally, web application module 612 may be in communication with web server 622 and an API server 618. In some embodiments, memory 610 may include API server 618 and a database 620. Database 620 may communicate with API server 618 and API server 618 may communicate with web application module 612.

In some embodiments, web application module 612 may send voice data to web server 622. Conversely, web server 622 may send intent and entity information to web application module 612.

In some embodiments, a user may provide a vocal input to user device 502, and user device 502 may be configured to convert the vocal input to voice data. Then, user device 502 may send the voice data to web application module 612. Specifically, in some embodiments, the voice data may be an input to interactive API module 626. Even further, the voice data may be sent to UI layer 614.

Interactive API module 626 is shown to communicate the voice data to speech conversion module 628. In some embodiments, speech conversion module 628 may be configured to convert voice data to text, which may be sent back to interactive API module 626. Upon receiving the converted text, interactive API module 626 may send the text to command identification module 630. In some embodiments, command identification module 630 may be configured to convert received text to an intent and entity form (e.g., an intent parameter and an entity parameter). Additionally, speech recognition module 632 may receive voice data from interactive API module 626. Speech recognition module 632 may be configured to determine a user identity based on the voice data, and may send the user identity to interactive API module 626. In some embodiments, outputs of the voice-enabled system may be specific to the user identity (e.g., how data is displayed, the level of detail provided, etc.).

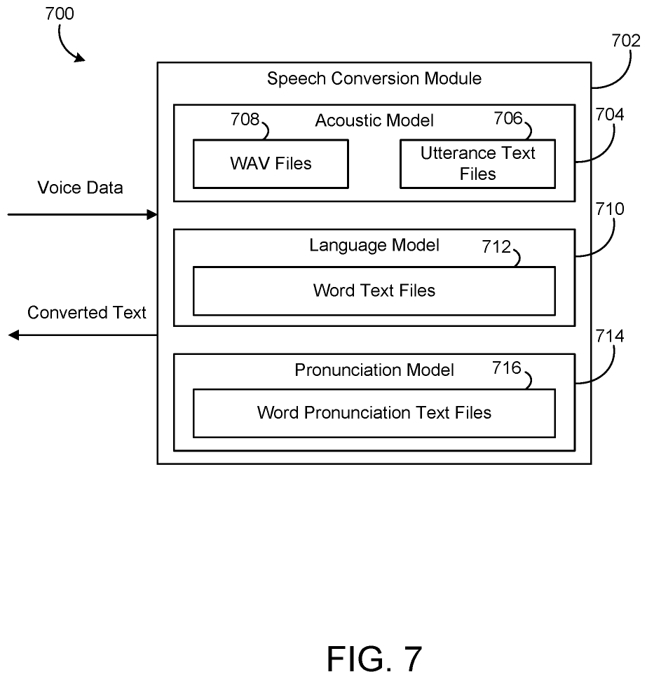

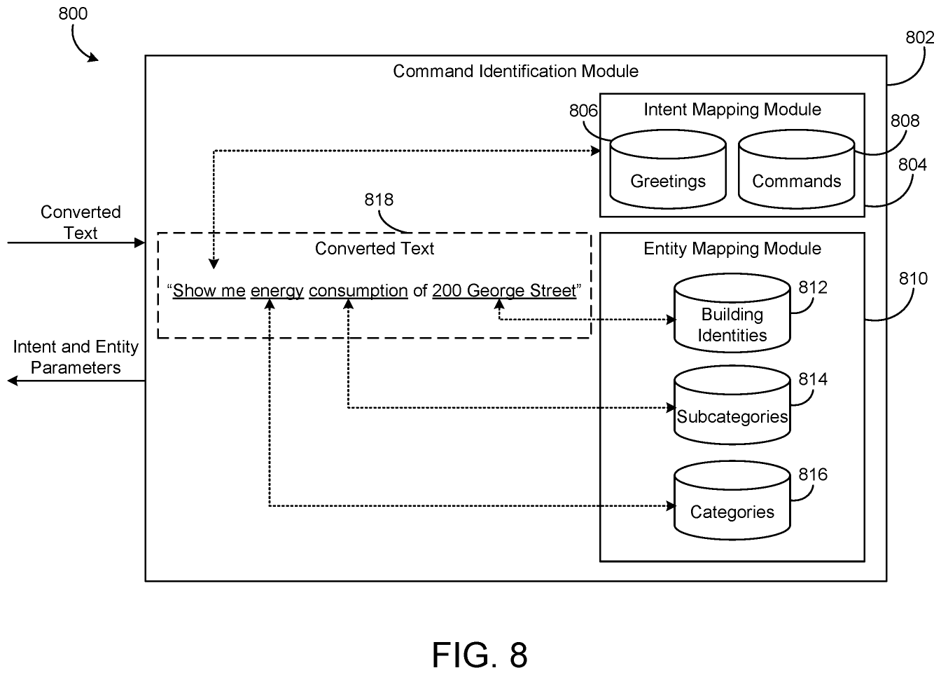

Speech conversion module 628, command identification module 630, and speech recognition module 632 may communicate with interactive API module 626. An embodiment of speech conversion module 628 is described in greater detail with respect to FIG. 7. Additionally, an embodiment of command identification module 630 is described in greater detail with respect to FIG. 8. In some embodiments, speech conversion module 628 and command identification module 630 may be within a single module.

As shown, interactive API module 626 may be configured to send the intent and entity parameters to web application module 612. In some embodiments, the intent and entity parameters may be sent to UI layer 614. UI layer 614 may then pass the intent and entity parameters to model layer 616. In some embodiments, model layer 616 may process the intent and entity parameters to determine what information the user is requesting (via the vocal input). Model layer 616 may then request data from API server 618. The requested data may correspond to the intent and entity parameters. In some embodiments, API server 618 may communicate with database 620 to look up information (e.g., equipment setpoint boundaries, equipment model information, etc.). Upon receiving information from database 620, API server 618 may communicate the information to model layer 616, which may, in turn, pass the information to UI layer 614. The user may then hear the information that was initially requested via user device 502. Alternatively, the user may see the information that was initially requested via a display on user device 502. Further, if the user requested to change an operating parameter, then communication with a building management system may occur.

In some embodiments, database 620 may be included in web application module 612 (see, e.g., FIG. 6). Alternatively, database 620 may be an external component that maintains communication with web application module 612 via API server 618. In some embodiments, database 620 may correspond to a building management system (e.g., the BMS described with respect to FIGS. 1-4). Accordingly, database 620 may store information corresponding to the building management system and the associated building subsystems (e.g., building subsystems 428). In some embodiments, the database may be updated to include current operating parameters of equipment.

In some embodiments, speech conversion module 628, command identification module 630, and/or speech recognition module 632 may be cloud-based. In some embodiments, the voice data may be communicated to speech conversion module 628 in the form of a byte array. Additionally, in some embodiments, interactive API module 626 may be configured to convert the received intent and entity parameters to a JavaScript Object Notation (JSON) format (which may be compatible with existing building management systems). Alternatively, the intent and entity parameters may be converted to a different format, based on the particular application.

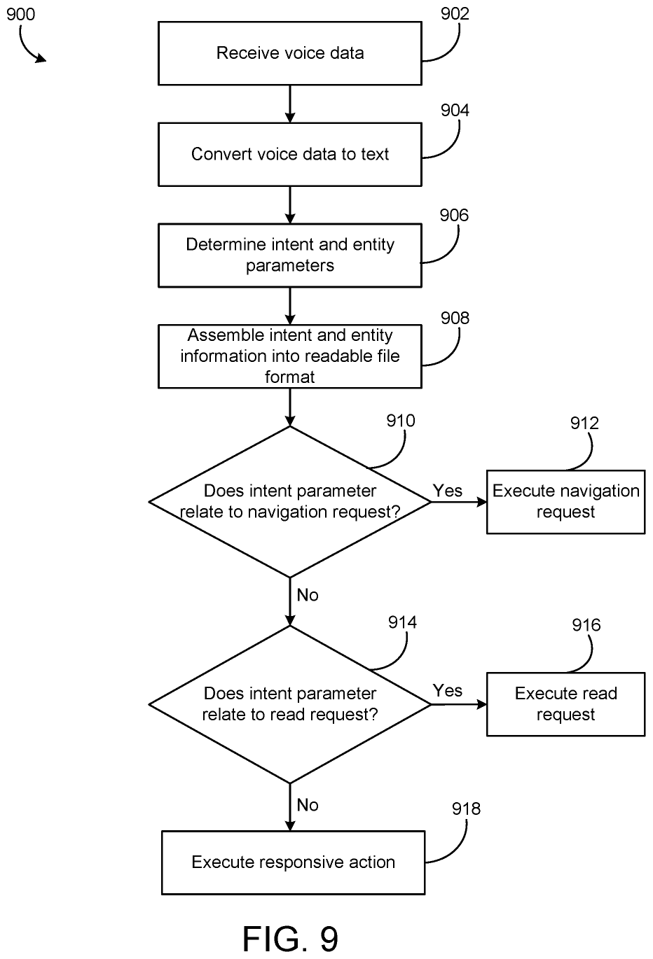

Details of communication between web application module 612, web server 622, API server 618, and database 620 are further described with respect to FIGS. 9-14.

Referring now to FIG. 7, a speech conversion system 700 is shown, according to some embodiments. Speech conversion system 700 may include a speech conversion module 702. In some embodiments, speech conversion module 702 may be the same or similar to speech conversion module 628, as shown and described herein.

As shown, speech conversion system 700 may include voice data as an input to speech conversion module 702. In some embodiments, speech conversion system 700 may include converted text as an output of speech conversion module 702. Accordingly, speech conversion module 702 may be configured to transform voice data to converted text.

In some embodiments, speech conversion module 702 may include an acoustic model 704, a language model 710, and a pronunciation model 714. Speech conversion module 702 may include additional modules.

In some embodiments, acoustic model 704 may process a speech waveform corresponding to a vocal input. Processing of the speech waveform may include analysis using statistical models. In some embodiments, acoustic model 704 may include WAV files 708 and utterance text files 706. WAV files 708 may be created from a vocal input, and WAV files 708 may be stored temporarily. In some embodiments, WAV files 708 may be stored in a memory (e.g., memory 610) and may be used to develop user profiles (e.g., to determine user identity from a vocal input).

In some embodiments, utterance text files 706 may be constructed using domain specific words (e.g., “building,” “energy,” “equipment,” “consumption,” etc.). Domain specific words may be included that correspond to HVAC system 100, waterside system 200, airside system 300, and BMS 400. Additional domain specific words may be included within utterance text files 706 based on the intended application of speech conversion module 702.

As shown, speech conversion module 702 may include language model 710. In some embodiments, language model 710 may include word text files 712. Language model 710 may be used to store domain specific words. In some situations, utterance text files 706 may not be needed. In those situations, word text files 712 may be used to configure domain specific words. As one non-limiting example, if utterance text files (audio files) are unavailable, a user may elect to use word text files 712 to express domain specific words.

In some embodiments, speech conversion module 702 may include pronunciation model 714. Generally, pronunciation model 714 may be configured to interpret vocal data in view of elements such as regional dialects, alternative pronunciations of words, etc. In some embodiments, pronunciation model 714 includes word pronunciation text files 716. Word pronunciation text files 716 may include pronunciation data. In some situations, it may be beneficial to use pronunciation model 714 to reduce error associated with vocal input recognition.

Still referring to pronunciation model 714, speech conversion module 702 may be trained to recognize and translate specific naming conventions within the BMS from audio to text. In some embodiments, naming conventions may include special characters such as “_,” “-,” “|,” etc. However, a user may not speak special characters when interacting with a voice-enabled system. Accordingly, pronunciation model 714 may define a pronunciation of a group of characters or words and its corresponding text response. As one non-limiting example embodiment, a text string “CH14-L12.L14” may be pronounced by a user as “CH14 L12 L14.” Pronunciation model 714 may be used to relate a known pronunciation with the appropriate text string.

In some embodiments, speech conversion module 702 may implement the Language Understanding Service (LUIS), as developed by Microsoft™.

Referring now to FIG. 8, a command identification system 800 is shown, according to some embodiments. Command identification system 800 may include a command identification module 802. In some embodiments, command identification module 802 may be the same or similar to command identification module 630, as shown and described herein.

As shown, command identification system 800 may include converted text 818 as an input to command identification module 802. In some embodiments, command identification system 800 may include intent and entity parameters as an output of command identification module 802. Accordingly, command identification module 802 may be configured to transform converted text 818 to intent and entity parameters. In some embodiments, command identification module 802 may include an intent mapping module 804 and an entity mapping module 810.

In some embodiments, converted text 818 may be used as an input to intent mapping module 804. As shown, intent mapping module 804 may include a greetings database 806 and a commands database 808. In some embodiments, additional databases may be included. In some situations, it may be beneficial to update greetings database 806 and/or commands database 808 over time. For example, predetermined greetings may be stored within greetings database 806, and additional greetings may be added to greetings database 806 based on vocal inputs (e.g., converted text) during operation. Similarly, for example, predetermined commands may be stored within commands database 808, and additional commands may be added to commands database 808 based on vocal inputs (e.g., converted text) during operation.

In some embodiments, intent mapping module 804 may process converted text 818 and determine if a greeting and/or command is present. As shown, for example, converted text 818 includes the expression “show me.” Intent mapping module 804 may compare the expression to the contents of greetings database 806 and/or commands database 808.

In the “show me” example, intent mapping module 804 may recognize that the expression may refer to a command intent. Even further, command database 808 may interpret “show me” as corresponding to a visual intent. Accordingly, command identification module 802 may output a “visual” intent.

As another non-limiting example, converted text may include the expression “tell me.” Intent mapping module 804 may recognize that the expression may refer to a command intent. Even further, command database 808 may interpret “tell me” as corresponding to an audio intent. Accordingly, command identification module 802 may output an “audio” intent.

As another non-limiting example, converted text may include the expression “turn on.” Intent mapping module 804 may recognize that the expression may refer to a command intent. Even further, command database 808 may interpret “turn on” as corresponding to a control intent. Accordingly, command identification module 802 may output a “control” intent. Command intents are not limited to those described in the present disclosure.

As another non-limiting example, converted text may include the expression “hello.” Intent mapping module 804 may recognize that the expression may refer to a greeting intent. Accordingly, command identification module 802 may output a “greeting” intent. Greeting intents are not limited to those described in the present disclosure.

As shown, converted text 818 may be used as an input to entity mapping module 810. In some embodiments, entity mapping module 810 may include a building identities database 812, a subcategories database 814, and a categories database 816. In some embodiments, additional databases may be included. In some situations, it may be beneficial to update building identities database 812, subcategories database 814, and/or categories database 816 over time. For example, predetermined building identities may be stored within building identities database 812, and additional building identities may be added to building identities database 812 based on vocal inputs (e.g., converted text) during operation. Similarly, for example, predetermined subcategories may be stored within subcategories database 814, and additional subcategories may be added to subcategories database 814 based on vocal inputs (e.g., converted text) during operation. Further, for example, predetermined categories may be stored within categories database 816, and additional categories may be added to categories database 816 based on vocal inputs (e.g., converted text) during operation.

In some embodiments, entity mapping module 810 may process converted text 818 and determine if a building identity, subcategory, and/or category is present. As shown, for example, converted text 818 includes the expressions “energy,” “consumption,” and “200 George Street.” Entity mapping module 804 may compare the expressions to the contents of building identities database 812, subcategories database 814, and/or categories database 816.

In the “energy” example, entity mapping module 810 may recognize that the expression may refer to a categories entity. Even further, categories database 816 may interpret “energy” as corresponding to an energy entity. Accordingly, command identification module 802 may output an “energy” entity. Category entities are not limited to those described in the present disclosure.

In the “consumption” example, entity mapping module 810 may recognize that the expression may refer to a subcategories entity. Even further, subcategories database 814 may interpret “consumption” as corresponding to a consumption entity. Accordingly, command identification module 802 may output a “consumption” entity. Subcategory entities are not limited to those described in the present disclosure.

In the “200 George Street” example, entity mapping module 810 may recognize that the expression may refer to a building entity. Even further, building identities database 812 may interpret “200 George Street” as corresponding to a building entity. Accordingly, command identification module 802 may output a “building” entity. Building entities are not limited to those described in the present disclosure.

In some embodiments, categories database 816 may include categories corresponding to different elements within BMS 400. Categories may include elements such as energy, equipment, etc. In some embodiments, subcategories database 814 may include subcategories corresponding to different elements within BMS 400. Subcategories may include elements such as consumption, speed, pressure, faults, etc. In some embodiments, building identities database 812 may include identities corresponding to different buildings. In some situations, it may be beneficial to utilize BMS 400 within a plurality of buildings.

In some embodiments, command identification module 802 may implement the Custom Recognition Intelligent Service (CRIS), as developed by Microsoft™.

Referring now to FIG. 9, a flowchart of a method 900 for analyzing voice data is shown, according to some embodiments. In some embodiments, method 900 may be implemented by a controller (e.g., BAS controller 366, controller 508, controller 602, etc.) in communication with building subsystems.

Method 900 is shown to include receiving voice data (step 902). In some embodiments, a vocal input may be issued by a user. Further, in some embodiments, the vocal input may be sent to a user device (e.g. user device 502), and the user device may send the corresponding voice data to a controller. In some embodiments, the voice data may include a request to hear or view information associated with a building or multiple buildings. Further, in some embodiments, the voice data may include a request to update an operating parameter corresponding to a building subsystem (e.g., building subsystems 428).

Method 900 is further shown to include converting the voice data to text (step 904). In some embodiments, the user device may convert the voice data to text. Alternatively, the voice data may be sent to a web server (e.g., web server 622) to be converted to text. Once the voice data is converted to text, method 900 is shown to include determining intent and entity parameters that correspond to the converted text (step 906). In some embodiments, determining the intent and entity parameters may be performed by a web server (e.g., web server 622). Further, determining the intent and entity parameters may be performed by a command identification module (e.g., command identification module 630).

Still referring to FIG. 9, method 900 is shown to include assembling the intent and entity parameters into a readable file format (step 908). In some situations, it may be beneficial to assemble the intent and entity parameters into a JavaScript Object Notation (JSON) format. Alternatively, a different file format may be used. In some embodiments, the file format may be selected based on an existing building management system.

Method 900 is shown to include determining if the intent and entity parameters relates to a navigation request (step 910). In some embodiments, a “show me” intent may correspond to a navigation request. If the intent and entity parameters do relate to a navigation request (i.e., the result of step 910 is “yes”), then a navigation request may be executed (step 912). In some embodiments, the navigation request may result in a plurality of web page navigations to occur. Further, in some embodiments, a user may be provided with a web page that corresponds to the intent and entity parameters. The web page may be displayed on a user device (e.g., user device 502).

If the intent and entity parameters do not relate to a navigation request (i.e., the result of step 910 is “no”), then it may be determined if the intent and entity parameters relate to a read request (step 914). In some embodiments, a “read me” intent may correspond to a read request. If the intent and entity parameters do relate to a read request (i.e., the result of step 914 is “yes”), then a read request may be executed (step 916). In some embodiments, a read request may result in the look-up of information related to the intent and entity parameters. Further, in some embodiments, a user may be provided with an audio output that corresponds to the retrieved information. In some situations, a user device (e.g., user device 502) may output the audio.

If the intent and entity parameters do not relate to a read request (i.e., the result of step 914 is “no”), then a responsive action may be executed (step 918). In some embodiments, the responsive action may include updating an operating parameter within a building subsystem. In some embodiments, the responsive action may include alerting the user that the request could not be processed (e.g., the request was not understood, the request did not correspond to known entity and intent parameters, etc.).

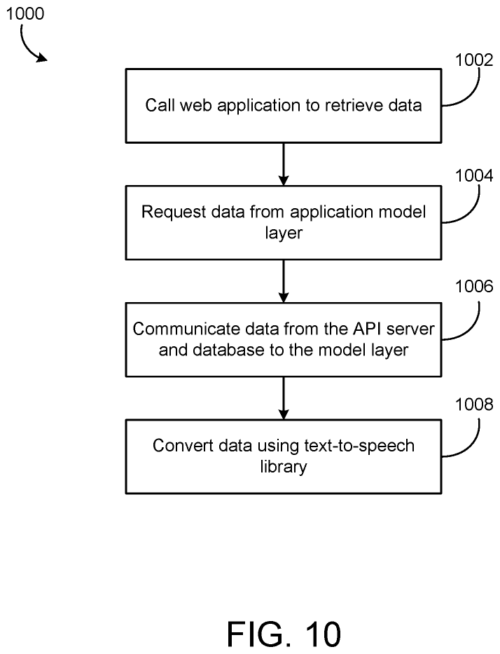

Referring now to FIG. 10, a flowchart of a method 1000 for retrieving data from a building management system is shown, according to some embodiments. In some embodiments, method 1000 may occur at step 916 of FIG. 9 (i.e., executing a read request). As shown, method 1000 includes calling a web application (e.g., web application module 612) to retrieve data (step 1002). In some embodiments, the desired data corresponds to intent and entity parameters that may be derived from voice data (as previously described). The web application may be provided with the intent and entity parameters.

Method 1000 may further include requesting data from the web application model layer (step 1004). Once the data has been requested and retrieved, the data from an API server and/or database may be communicated back to the model layer (i.e., back to the web application) at step 1006. Method 1000 is further shown to include converting the data using a text-to-speech library (step 1008). The conversion of the data may produce an audio output (e.g., via speakers on a user device). In some situations, receiving the requested data in an audio form may be beneficial. As one non-limiting example, verbally requesting data via a smartwatch and having the requested data read back to you may be easier than trying to read information from the smartwatch display. Additionally, this may allow for a user to find information while doing other tasks (i.e., the user can perform “hand free” look-ups).

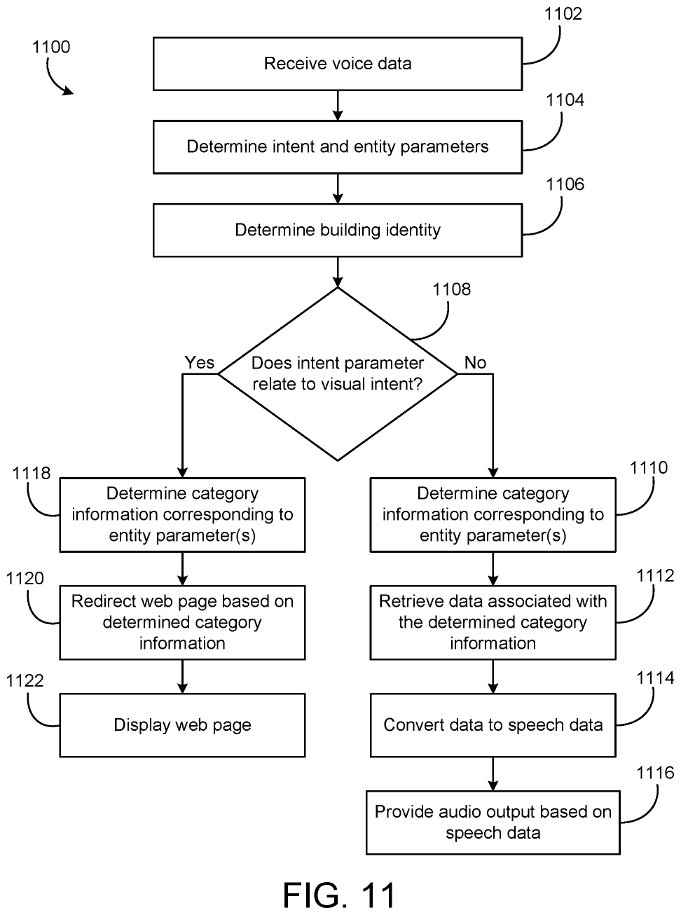

Referring now to FIG. 11, a flowchart of a method 1100 for analyzing voice data is shown, according to some embodiments. As shown, method 1100 includes receiving voice data (step 1102). In some embodiments, the voice data may be received from a user device (e.g., user device 502). Method 1100 may further include determining intent and entity parameters (step 1104). The intent and entity parameters may be determined from the voice data of step 1102. Next, method 1100 is shown to include determining a building identity (step 1106). The building identity may be included in the intent and entity parameters. Alternatively, a user may be prompted to provide an indication of building identity.

Method 1100 may further include determining if the intent parameter relates to a visual intent (step 1108). If the intent parameter does not relate to a visual intent (i.e., the result of step 1108 is “no”), then method 1100 is shown to include determining category information corresponding to the entity parameter(s). In some embodiments, the category information may relate to aspects of the building management system (e.g., parameters of building subsystems 428). Method 1100 is further shown to include retrieving data associated with the determined category information (step 1112). In some embodiments, the data may be retrieved from an API server and/or database. Once the data is retrieved, the data may be converted from text to speech (step 1114). In some embodiments, the data may be converted using a text-to-speech library. Method 1100 may further include providing audio output based on the converted speech data (step 1116). In some embodiments, a user device may be configured to output the audio (e.g., via speakers).

Still referring to method 1100, if it is determined (at step 1108) that the intent parameter does relate to visual intent (i.e., the result of step 1108 is “yes”), then method 1100 is shown to include determining category information corresponding to the entity parameter(s). In some embodiments, the category information may relate to aspects of the building management system (e.g., parameters of building subsystems 428). Method 1100 may further include redirecting a web page based on the determined category information (step 1120). In some embodiments, redirecting the web page may include navigating to a particular web page. Further, the particular web page may include information relating to the determined category information. Next, method 1100 is shown to include displaying the web page (step 1122). In some embodiments, the web page may be displayed on a user interface (e.g., a user interface on a user device).

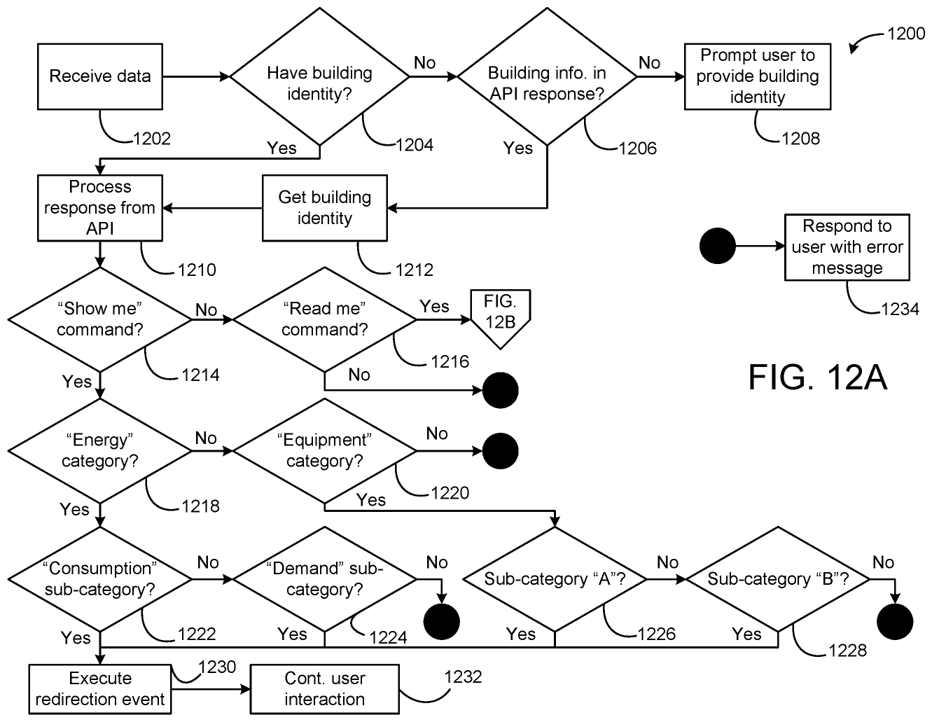

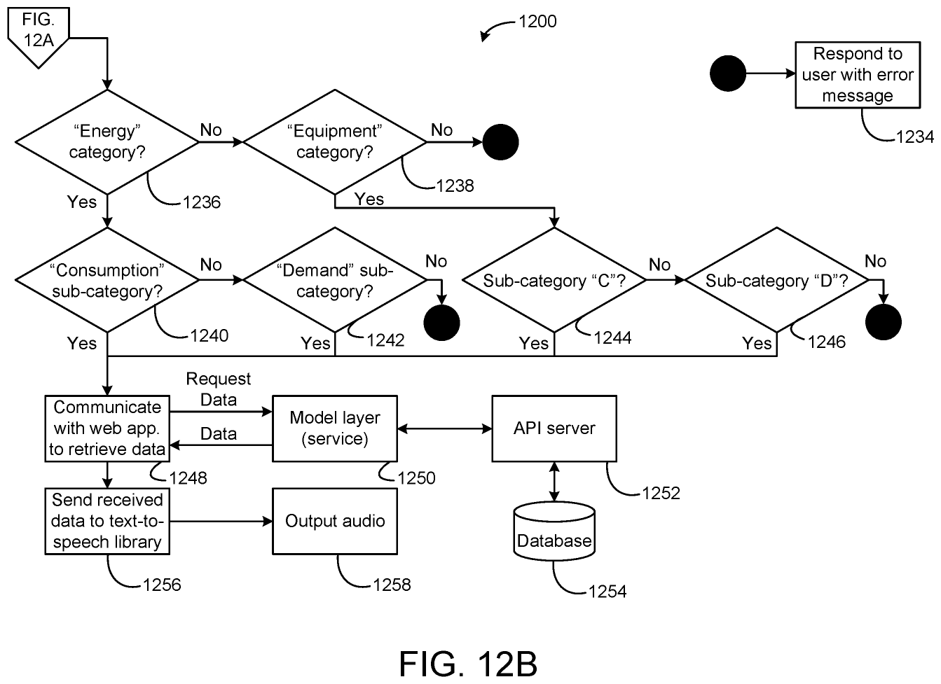

Referring now to FIGS. 12A-12B, a flowchart of a method 1200 for receiving, analyzing, and responding to a vocal input is shown, according to some embodiments. As shown, example intent parameters may include “show me” and/or “tell me.” Further, example entity parameters may include “energy,” “equipment,” “consumption,” and/or “demand.” Accordingly, additional or different intent and entity parameters may be used.

Method 1200 is shown to include receiving data (step 1202). In some embodiments, the data may be received from a web server (e.g., web server 622). The data may be voice data corresponding to a user's vocal input. More specifically, the data may include intent and entity parameters that correspond to the user's vocal input. For example, interactive API module 626 may receive voice data and convert it to intent and entity parameters prior to sending it to web application module 612.

Method 1200 is further shown to include determining if building details are known (step 1204). In some embodiments, building details may refer to a building name, address, or other unique identifier. If the building details are known (i.e., the result of step 1204 is “yes”), then the response from the API may be processed (step 1210). If the building details are not known (i.e., the result of step 1204 is “no”), then it may be determined if building information is included within the API response (step 1206). For example, the API response may include an entity parameter that refers to a specific building. If the building details are not within the API response (i.e., the result of step 1206 is “no”), then the user may be prompted to provide building details (step 1208). In some embodiments, the user may be prompted visually and/or using audio. Further, a user device (e.g., user device 502) may be used to prompt the user. The user may provide a verbal response to the prompt, which may then be processed beginning at step 1202. If it is determined that the building information is within the API response (i.e., the result of step 1206 is yes), then the building details may be retrieved at step 1212 (e.g., an entity parameter that includes building information may be used to determine name, location, etc. of the building).

As shown, once building details are known, the response from the API may be processed (step 1210). As shown by method 1200, the response from the API may be processed by analyzing the intent and entity parameters. Method 1200 may include determining if the intent parameter corresponds to a “show me” command at step 1214 (i.e., the user would like to view information via a display). If the intent parameter corresponds to a “show me” command (i.e., the result of step 1214 is “yes”), then the entity parameter(s) may be analyzed.

Alternatively, if the intent parameter does not correspond to a “show me” command (i.e., the result of step 1214 is “no”), then method 1200 is shown to include determining if the intent parameter corresponds to a “read me” command (step 1216). If the intent parameter does not correspond to a “read me” command (i.e., the result of step 1216 is “no”), then an error message may be provided to the user (step 1234). In some embodiments, the error message may occur visually via a display (e.g., via user device 502), and/or using audio (e.g., via speakers corresponding to user device 502).

If the intent parameter does correspond to a “read me” command (i.e., the result of step 1216 is “yes”), then method 1200 is shown to include determining if an entity parameter corresponds to an “energy” category (step 1218). If an entity parameter does not correspond to an “energy” category (i.e., the result of step 1218 is “no”), then method 1200 is shown to include determining if the entity parameter corresponds to an “equipment” category (step 1220). If an entity parameter does not correspond to an “equipment” category (i.e., the result of step 1220 is “no”), then an error message may be provided to the user (step 1234). Details of the error message are described above.

If an entity parameter does correspond to an “energy” category (i.e., the result of step 1218 is “yes”), then method 1200 is shown to include determining if an entity parameter corresponds to a “consumption” sub-category (step 1222). If an entity parameter does not correspond to a “consumption” sub-category (i.e., the result of step 1222 is “no”), then method 1200 is shown to include determining if an entity parameter corresponds to a “demand” sub-category (step 1224). If an entity parameter does not correspond to a “demand” sub-category (i.e., the result of step 1224 is “no”), then an error message may be provided to the user (step 1234). Details of the error message are described above. If an entity parameters does correspond to a “consumption” sub-category (i.e., the result of step 1222 is “yes”), then method 1200 is shown to include executing a redirection event (step 1230).

If an entity parameter does correspond to an “equipment” category (i.e., the result of step 1220 is “yes”), then method 1200 is shown to include determining if an entity parameter corresponds to a subcategory “A.” Subcategory “A” may represent any equipment parameter that is known within a building, and subcategory “A” is intended to illustrate the breadth of potential applications and uses of method 1200. In some embodiments, for example, subcategory “A” may correspond to a “temperature” subcategory or a “pressure” category, etc. If an entity parameter corresponds to subcategory “A” (i.e., the result of step 1226 is “yes”), then method 1200 is shown to include executing a redirection event (step 1230). Alternatively, if an entity parameter does not correspond to subcategory “A” (i.e., the result of step 1226 is “no”), then method 1200 is shown to include determining if an entity parameter corresponds to subcategory “B” (step 1228). Similarly to subcategory “A,” subcategory “B” may represent any equipment parameter that is known within a building, and subcategory “B” is intended to illustrate the breadth of potential applications and uses of method 1200. If an entity parameter corresponds to subcategory “B” (i.e., the result of step 1228 is “yes”), then method 1200 is shown to include executing a redirection event (step 1230). Alternatively, if an entity parameter does not correspond to subcategory “A” (i.e., the result of step 1226 is “no”), then method 1200 is shown to include providing an error message to the user (step 1234). The details of the error message are described above.

Method 1200 is shown to include executing a redirection event (step 1230). In some embodiments, the redirection event may include navigating to a web page that corresponds to the user's initial vocal input (e.g., at step 1202). The web page may correspond to the building, intent parameter, and entity parameters, which may be determined through steps 1204-1228. In some embodiments, the redirection event may include a plurality of web page navigations based on the data received at step 1202. Further, in some embodiments, a plurality of web page navigations may occur without additional user input (verbal and/or physical). As one non-limiting example, if the user's vocal input corresponds to “building 1,” a “show me” intent, an “energy” category entity, and a “consumption” category entity, then the redirection event may include navigating to a web page that includes the energy consumption of building 1.

Method 1200 is shown to include continuing a user interaction (step 1232). In some embodiments, the web page may be displayed to a user via the display of a user device (e.g., user device 502). Additionally, in some embodiments, a user may be able to specify how the web page is displayed. For example, a user may verbally request to view data from a specific time period (e.g., one week, six months, one year, etc.). In some embodiments, a user may specify how the web page is displayed via a physical interaction with a user device (e.g., selecting a display option via a touch-screen, a push button, etc.).

Returning now to step 1216, method 1200 includes determining if an intent parameter corresponds to a “read me” command. If the intent parameter does not correspond to a “read me” command (i.e., the result of step 1216 is “no”), then method 1200 is shown to include providing an error message to the user (step 1234). Alternatively, if the intent parameter does correspond to a “read me” command (i.e., the result of step 1216 is “yes”), then method 1200 is shown to include determining if an entity parameter corresponds to an “energy” category (step 1236, FIG. 12B).

If an entity parameter does not correspond to an “energy” category (i.e., the result of step 1236 is “no”), then method 1200 is shown to include determining if the entity parameter corresponds to an “equipment” category (step 1238). If an entity parameter does not correspond to an “equipment” category (i.e., the result of step 1238 is “no”), then an error message may be provided to the user (step 1234). Details of the error message are described above.

If an entity parameter does correspond to an “energy” category (i.e., the result of step 1236 is “yes”), then method 1200 is shown to include determining if an entity parameter corresponds to a “consumption” sub-category (step 1240). If an entity parameter does not correspond to a “consumption” sub-category (i.e., the result of step 1240 is “no”), then method 1200 is shown to include determining if an entity parameter corresponds to a “demand” sub-category (step 1242). If an entity parameter does not correspond to a “demand” sub-category (i.e., the result of step 1242 is “no”), then an error message may be provided to the user (step 1234). Details of the error message are described above. If an entity parameter does correspond to a “consumption” sub-category (i.e., the result of step 1240 is “yes”), then method 1200 is shown to include communicating with a web application (e.g., web application module 612) to retrieve data (step 1248).

If an entity parameter does correspond to an “equipment” category (i.e., the result of step 1238 is “yes”), then method 1200 is shown to include determining if an entity parameter corresponds to a subcategory “C.” Subcategory “C” may represent any equipment parameter that is known within a building, and subcategory “C” is intended to illustrate the breadth of potential applications and uses of method 1200. In some embodiments, for example, subcategory “C” may correspond to a “temperature” subcategory or a “pressure” category, etc. If an entity parameter corresponds to subcategory “C” (i.e., the result of step 1244 is “yes”), then method 1200 is shown to include communicating with a web application (e.g., web application module 612) to retrieve data (step 1248). Alternatively, if an entity parameter does not correspond to subcategory “C” (i.e., the result of step 1244 is “no”), then method 1200 is shown to include determining if an entity parameter corresponds to subcategory “D” (step 1246). Similarly to subcategory “C,” subcategory “D” may represent any equipment parameter that is known within a building, and subcategory “D” is intended to illustrate the breadth of potential applications and uses of method 1200. If an entity parameter corresponds to subcategory “D” (i.e., the result of step 1246 is “yes”), then method 1200 is shown to include communicating with a web application (e.g., web application module 612) to retrieve data (step 1248). Alternatively, if an entity parameter does not correspond to subcategory “D” (i.e., the result of step 1246 is “no”), then method 1200 is shown to include providing an error message to the user (step 1234). The details of the error message are described above.

Method 1200 is shown to include communicating with a web application (e.g., web application module 612) to retrieve data (step 1248). In some embodiments, step 1248 may include sending a data request to a web application (e.g., web application module 612). The data request may correspond to the building, intent parameter, and entity parameters, which may be determined through steps 1204-1246. In some embodiments, retrieving data may occur without additional user input (verbal and/or physical). As one non-limiting example, if the user's vocal input corresponds to “building 1,” a “read me” intent, an “energy” category entity, and a “consumption” category entity, then the web application may retrieve data that includes the energy consumption of building 1.

Method 1200 is shown to include requesting data from a model layer (e.g., model layer 616) (step 1250). In some embodiments, the model layer may be included in the web application. The model layer may then communicate with an API server to retrieve the requested data (step 1252). In some embodiments, the API server of step 1252 may be the same or similar to API server 618, as described with respect to FIG. 6. Method 1200 is additionally shown to include retrieving data from a database (step 1254). The database in step 1254 may be the same or similar to database 620, as described with respect to FIG. 6. The database may include data such as, for example, energy consumption, energy demand, building information, etc. In some embodiments, the database information may correspond to pre-programmed intent and entity parameters.

Method 1200 may further include communicating the data (from the database) corresponding to the requested data to the web application. As shown, the data may be sent to the API server, which then sends the data to the model layer of the web application. Once the requested data has been received by the web application, method 1200 is shown to include sending the received data to a text-to-speech library (step 1256). In some embodiments, the text-to-speech library may be included in the web application. Alternatively, the text-to-speech library may be an external component. The text-to-speech library may be configured to translate the received data from text form to audio. As shown, once the received data is translated to audio, the received data may be read to the user (step 1258). In some embodiments, a user device (e.g., user device 502) may be configured to output the audio corresponding to the received data. The user device may include a speaker, for example, configured to output audio.

As one non-limiting example, a user may tell a user device (e.g., user device 502) “read me the energy demand of building 2.” Using method 1200, it may be determined that the vocal input corresponds to building 2, a “read me” intent, an “energy” category entity, and a “demand” sub-category entity. Method 1200 may determine the data corresponding to the building, and the intent and entity parameters. In some embodiments, the data may be retrieved from a database. The retrieved data may then be read back to the user via the user device. In this way, a user may ask for information, and have the information read back to them.

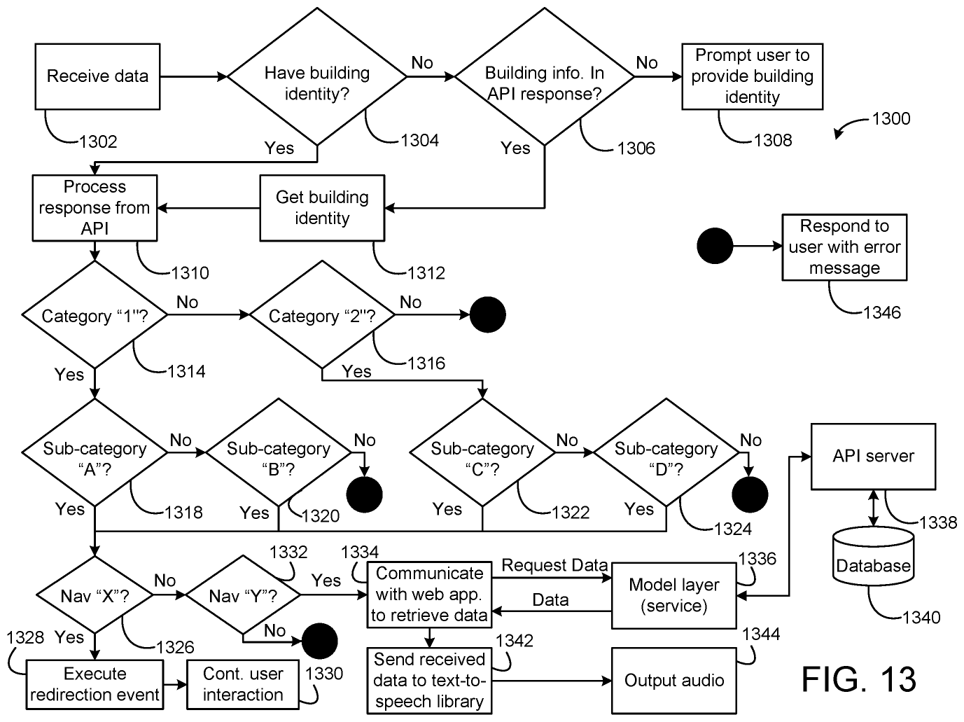

Referring now FIG. 13, a flowchart of another method 1300 for receiving, analyzing, and responding to a vocal input is shown, according to some embodiments. As shown, example intent parameters may relate to navigation and include Nav “X” and Nav “Y.” Further, example entity parameters include Category “1,” Category “2,” Sub-category “A,” etc. The example intent and entity parameters are intended to be merely illustrative of the ability of a user to customize intent and entity parameters, depending on the application. Accordingly, additional or different intent and entity parameters may be used.

Method 1300 is shown to include receiving data (step 1302). In some embodiments, the data may be received from a web server (e.g., web server 622). The data may be audio data corresponding to a user's speaking a request. More specifically, the data may include intent and entity parameters that correspond to the user's vocal input. For example, interactive API module 626 may receive voice data and convert it to intent and entity parameters prior to sending it to web application module 612.

Method 1300 is further shown to include determining if building details are known (step 1304). In some embodiments, building details may refer to a building name, address, or other unique identifier. If the building details are known (i.e., the result of step 1304 is “yes”), then the response from the API may be processed (step 1210). If the building details are not known (i.e., the result of step 1304 is “no”), then it may be determined if building information is included within the API response (step 1306). For example, the API response may include an entity parameter that refers to a specific building. If the building details are not within the API response (i.e., the result of step 1306 is “no”), then the user may be prompted to provide building details (step 1308). In some embodiments, the user may be prompted visually and/or using audio. Further, a user device (e.g., user device 502) may be used to prompt the user. The user may provide a verbal response to the prompt, which may then be processed beginning with step 1302. If it is determined that the building information is within the API response (i.e., the result of step 1306 is yes), then the building details may be retrieved at step 1312 (e.g., an entity parameter that includes building information may be used to determine name, location, etc. of the building).

As shown, once building details are known, the response from the API may be processed (step 1310). As shown by method 1300, the response from the API may be processed by analyzing the intent and entity parameters. Method 1300 is shown to include determining if an entity parameter corresponds to category “1” (step 1314). If an entity parameter does not correspond to category “1” (i.e., the result of step 1314 is “no”), then method 1300 is shown to include determining if the entity parameter corresponds to category “2” (step 1316). If an entity parameter does not correspond to category “2” (i.e., the result of step 1316 is “no”), then an error message may be provided to the user (step 1346). In some embodiments, the error message may occur visually via a display (e.g., via user device 502), and/or using audio (e.g., via speakers corresponding to user device 502).

If an entity parameter does correspond to category “1” (i.e., the result of step 1314 is “yes”), then method 1300 is shown to include determining if an entity parameter corresponds to sub-category “A” (step 1318). If an entity parameter does not correspond to sub-category “A” (i.e., the result of step 1318 is “no”), then method 1300 is shown to include determining if an entity parameter corresponds to sub-category “B” (step 1320). If an entity parameter does not correspond to sub-category “B” (i.e., the result of step 1320 is “no”), then an error message may be provided to the user (step 1346). Details of the error message are described above. If an entity parameters does correspond to sub-category “B” (i.e., the result of step 1320 is “yes”), then method 1300 is shown to include determining if an intent parameters corresponds to Nav “X” (step 1326).

If an entity parameter does correspond to category “2” (i.e., the result of step 1316 is “yes”), then method 1300 is shown to include determining if an entity parameter corresponds to a subcategory “C.” If an entity parameter corresponds to subcategory “C” (i.e., the result of step 1322 is “yes”), then method 1300 is shown to include determining if an intent parameters corresponds to Nav “X” (step 1326). Alternatively, if an entity parameter does not correspond to subcategory “C” (i.e., the result of step 1322 is “no”), then method 1300 is shown to include determining if an entity parameter corresponds to subcategory “D” (step 1324). If an entity parameter corresponds to subcategory “D” (i.e., the result of step 1324 is “yes”), then method 1300 is shown to include determining if an intent parameter corresponds to Nav “X” (step 1326). Alternatively, if an entity parameter does not correspond to subcategory “D” (i.e., the result of step 1324 is “no”), then method 1300 is shown to include providing an error message to the user (step 1346). The details of the error message are described above.

Method 1300 may include determining if the intent parameter corresponds to Nav “X” at step 1326 (e.g., the user would like to view information via a display). If the intent parameter corresponds to a Nav “X” command (i.e., the result of step 1326 is “yes”), then a redirection event may be executed.

Method 1300 is shown to include executing a redirection event (step 1328). In some embodiments, the redirection event may include navigating to a web page that corresponds to the user's initial vocal input (e.g., at step 1302). The web page may correspond to the building, intent parameter, and entity parameters, which may be determined through steps 1304-1332. In some embodiments, the redirection event may include a plurality of web page navigations based on the data received at step 1302. Further, in some embodiments, a plurality of web page navigations may occur without additional user input (verbal and/or physical).

Method 1300 is shown to include continuing user interaction (step 1330). In some embodiments, receiving data may include receiving a web page resulting from the redirection event. The web page may be displayed to a user. In some embodiments, the web page may be displayed to a user via the display of a user device (e.g., user device 502). Additionally, in some embodiments, a user may be able to specify how the web page is displayed. For example, a user may verbally request to view data from a specific time period (e.g., one week, six months, one year, etc.). In some embodiments, a user may specify how the web page is displayed via a physical interaction with a user device (e.g., selecting a display option via a touch-screen, a push button, etc.).

Alternatively, if the intent parameter does not correspond to a Nav “X” command (i.e., the result of step 1326 is “no”), then method 1300 is shown to include determining if the intent parameter corresponds to a Nav “Y” command (step 1332). If the intent parameter does not correspond to a Nav “Y” command (i.e., the result of step 1332 is “no”), then an error message may be provided to the user (step 1346).

If the intent parameters does correspond to a Nav “Y” command (i.e., the result of step 1332 is “yes”), then method 1300 is shown to include communicating with a web application (e.g., web application module 612) to retrieve data (step 1334). In some embodiments, step 1334 may include sending a data request to a web application (e.g., web application module 612). The data request may correspond to the building, intent parameter, and entity parameters, which may be determined through steps 1304-1332. In some embodiments, retrieving data may occur without additional user input (verbal and/or physical).

Method 1300 is shown to include requesting data from a model layer (e.g., model layer 616) (step 1336). In some embodiments, the model layer may be included in the web application. The model layer may then communicate with an API server to retrieve the requested data (step 1338). In some embodiments, the API server of step 1338 may be the same or similar to API server 618, as described with respect to FIG. 6. Method 1300 is additionally shown to include retrieving data from a database (step 1340). The database in step 1340 may be the same or similar to database 620, as described with respect to FIG. 6. The database may include data such as, for example, energy consumption, energy demand, building information, etc. In some embodiments, the database information may correspond to pre-programmed intent and entity parameters.

Method 1300 may further include communicating the data (from the database) corresponding to the requested data to the web application. As shown, the data may be sent to the API server, which then sends the data to the model layer of the web application. Once the requested data has been received by the web application, method 1300 is shown to include sending the received data to a text-to-speech library (step 1342). In some embodiments, the text-to-speech library may be included in the web application. Alternatively, the text-to-speech library may be an external component. The text-to-speech library may be configured to translate the received data from text form to audio. As shown, once the received data is translated to audio, the received data may be read to the user (step 1344). In some embodiments, a user device (e.g., user device 502) may be configured to output the audio corresponding to the received data. The user device may include a speaker, for example, configured to output audio.

As one non-limiting example, a user may tell a user device (e.g., user device 502) “read me the energy demand of building 2.” Using method 1300, it may be determined that the vocal input corresponds to building 2, a “read me” intent, an “energy” category entity, and a “demand” sub-category entity. Method 1300 may determine the data corresponding to the building, and the intent and entity parameters. In some embodiments, the data may be retrieved from a database. The retrieved data may then be read back to the user via the user device. In this way, a user may ask for information, and have the information read back to them.

Categories “1” and “2” may represent any entity that corresponds to a building. Similarly, subcategories “A,” “B,” “C,” and “D” may represent any entity that corresponds to a building. Nav “X” and “Y” may represent any intent that corresponds to a building.

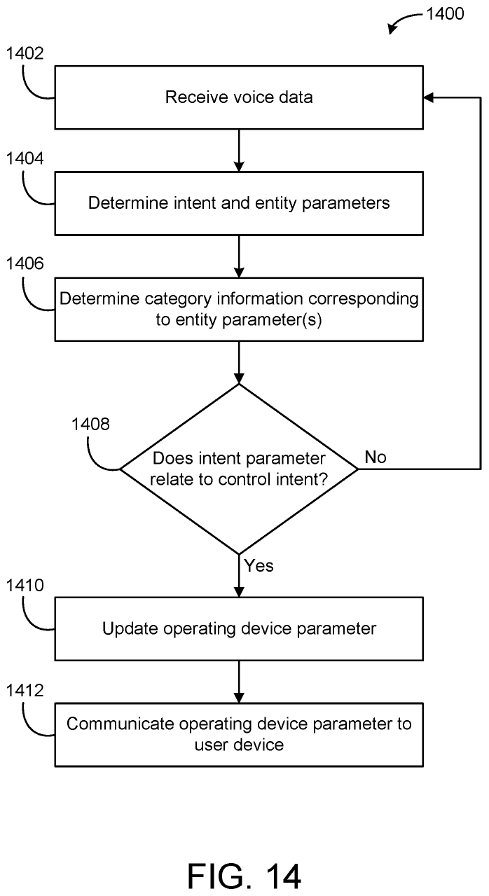

Referring now to FIG. 14, a flowchart of a method 1400 for controlling devices using voice data is shown, according to some embodiments. Method 1400 is shown to include receiving voice data (step 1402). The voice data may be received from a user device (e.g., user device 502). Next, method 1400 is shown to include determining intent and entity parameters (step 1404). In some embodiments, the intent and entity parameters may be determined from the voice data.

Method 1400 may further include determining category information corresponding to the entity parameter(s) (step 1406). In some embodiments, the category information may relate to aspects of the building management system (e.g., parameters of building subsystems 428). Method 1400 is shown to further include determining if the intent parameter relates to a control intent (step 1408). In some embodiments, a control intent may correspond to an operating device parameter.

If it is determined that the intent parameter does not relate to a control intent (i.e., the result of step 1408 is “no”), then method 1400 is shown to return to step 1402 (i.e., receiving voice data). Accordingly, if the intent parameter does not relate to a control intent, method 1400 waits for additional voice data. Alternatively, if it is determined that the intent parameter does relates to a control intent (i.e., the result of step 1408 is “yes”), then method 1400 is shown to include updating an operating device parameter (step 1410). By changing an operating device parameter, the building, equipment, and/or device may function differently. As one non-limiting example, changing a temperature setpoint will result in the HVAC system changing operation.

Method 1400 is shown to further include communicating the updated operating device parameter to a user device (step 1412). In some embodiments, user device 502 may receive the operating device parameter. The operating device parameter may be displayed or provided to the user via an audio output.

Method 1400 may be performed by a controller (e.g., BAS controller 366, controller 508, and/or controller 602). Advantageously, a user may update parameters within building subsystems (e.g., building subsystems 428) without having to manually input information. This may allow a user to control equipment in a hands-free manner. Further, if a user device does not have a large screen for accepting user input, then the user can still interact with the building management system via voice control.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A system for monitoring and controlling devices within a building management system (BMS), the system comprising:
a user device configured to receive a vocal input and convert the vocal input to voice data;
a BMS processor in communication with the user device and at least one operating device within the BMS and configured to:
convert voice data to at least one intent parameter and at least one entity parameter;
determine if the at least one intent parameter is one of a visual intent or an audio intent;
in response to a determination that the at least one intent parameter is the visual intent:
determine at least one category corresponding to the at least one entity parameter;
select and output a web page corresponding to the at least one category; and
in response to a determination that the at least one intent parameter is the audio intent:
determine at least one category corresponding to the at least one entity parameter;
retrieve and output operating device data corresponding to the at least one category;
wherein the user device is configured to output audio data corresponding to the operating device data and further configured to display the web page.

2. The system of claim 1, wherein the BMS processor is configured to output data without a physical input via the user device.

3. The system of claim 2, wherein the BMS processor is configured to execute a plurality of web page navigation steps in response to a single vocal input.

4. The system of claim 2, wherein the BMS processor is further configured to:
determine a user identity corresponding to the vocal input; and
customize the output data using the user identity.

5. The system of claim 1, wherein retrieving operating data comprises:
requesting operating data from a BMS application program interface (API) server; and
retrieving operating data from a BMS database via the BMS API server.

6. The system of claim 1, wherein the BMS processor is further configured to prompt a user input corresponding to a display type prior to outputting the web page.

7. The system of claim 1, wherein the at least one category corresponds to a BMS category selected from a group consisting of energy, equipment, and building.

8. The system of claim 1, wherein the BMS processor is further configured to:
receive the voice data;
convert the voice data to text data;
map at least one text element to the at least one intent parameter; and
map at least one text element to the at least one entity parameter.

9. A system for monitoring and controlling devices within a building management system (BMS), the system comprising:
a user device configured to receive a vocal input and convert the vocal input to voice data;
at least one operating device within a building;
a BMS processor in communication with the user device and the at least one operating device and configured to:
receive the voice data from the user device;
determine an intent parameter and at least one entity parameter from the voice data;
determine at least one category corresponding to the at least one entity parameter; and
update at least one operating device parameter corresponding to the at least one category upon the determination that the intent parameter is a control intent; and
communicate the at least one operating device parameter to the user device;
wherein the user device is configured to provide at least one of an audio output and a visual output based on the updated at least one operating parameter.

10. The system of claim 9, wherein updating the at least one operating device parameter changes a device operation.

11. The system of claim 9, wherein the BMS processor is further configured to:
determine and output a web page corresponding to the at least one category in response to a determination that the at least one intent parameter is a visual intent; and
retrieve and output operating device data corresponding to the at least one category in response to a determination that the at least one intent parameter is an audio intent.

12. The system of claim 9, wherein the BMS processor is configured to update the at least one operating device parameter using a single vocal input.

13. A method for monitoring and controlling devices within a building management system (BMS), the method comprising:
receiving voice data via a user device;
converting the voice data to at least one intent parameter and at least one entity parameter using a speech conversion system;
determining a building identity using the building management system;
determining if the at least one intent parameter is one of a visual intent or an audio intent;
in response to a determination that the at least one intent parameter is the visual intent:
determining at least one category corresponding to the at least one entity parameter;
selecting a web page based on the at least one category and the building identity;
displaying the web page on the user device; and
in response to a determination that the at least one intent parameter is the audio intent:
determining at least one category corresponding to the at least one entity parameter;
retrieving data corresponding to the at least one category and the building identity;
converting data to speech data; and
outputting audio corresponding to the speech data on the user device.

14. The method of claim 13, wherein the redirecting of the web page comprises a plurality of navigation steps.

15. The method of claim 13, wherein converting the voice data further comprises:
receiving the voice data;
converting the voice data to text data;
mapping at least one text element to the at least one intent parameter; and
mapping at least one text element to the at least one entity parameter.

16. The method of claim 15, further comprising converting the at least one intent parameter and the at least one entity parameter to a JavaScript Object Notation (JSON) format.

17. The method of claim 13, wherein the at least one category corresponds to a BMS category selected from a group consisting of energy, equipment, and building.

18. The method of claim 17, further comprising determining at least one subcategory corresponding to the at least one category.

19. The method of claim 13, further comprising:
determining a user identity corresponding to the voice data; and
customizing an output using the user identity.

20. The method of claim 13, wherein determining the building identity comprises:
determining if the voice data corresponds to the building identity; and
in response to a determination that the voice data does not correspond to the building identity, prompting additional input via the user device, the additional input corresponding to the building identity.
